(19) United States
(12) Patent Application Publication
(10) Pub. No.: US 2019/0047075 A1
(43) Pub. Date: Feb. 14, 2019

(54) RESISTANCE SPOT WELDING ENHANCED BY ELECTROMAGNETS

(71) Applicant: Novelis Inc., Atlanta, GA (US)

(72) Inventors: Courtney Timms, Canton, GA (US); Brian Paradis, Kennesaw, GA (US); Louis Mitchell Nazro, Canton, GA (US); Julio Malpica, Canton, GA (US); Rainer Kossak, South Lyon, MI (US); Samuel Robert Wagstaff, Marietta, GA (US); Xiao Chai, San Jose, CA (US); Patrick Lester, Atlanta, GA (US); Dechao Lin, Kennesaw, GA (US)

(73) Assignee: Novelis Inc., Atlanta, GA (US)

(21) Appl. No.: 16/101,589

(22) Filed: Aug. 13, 2018

Related U.S. Application Data
(60) Provisional application No. 62/545,150, filed on Aug. 14, 2017.

(51) Int. Cl. B23K 11/11; B23K 11/31

(52) U.S. Cl. CPC B23K 11/115; B23K 2103/10; B23K 11/31

(57) ABSTRACT

Disclosed are welds formed from improved resistance spot welding, as well as methods of improved resistance spot welding. Resistance spot welding includes positioning a magnet carrier having a plurality of electromagnets on at least one electrode of two electrodes. The method includes positioning a first metal sheet and a second metal sheet between the two electrodes where at least one of the first metal sheet or the second metal sheet includes an aluminum alloy. The method includes positioning the forming a weld nugget by applying a magnetic field from the plurality of electromagnets through the weld while applying a current through the electrodes to stir a portion of the first metal sheet and the second metal sheet forming a weld nugget and adjusting the magnetic field to control at least one characteristic of the weld nugget. Forming the weld nugget joins the first metal sheet with the second metal sheet.

### REFERENCE TO RELATED APPLICATION

This application claims the benefit of U.S. Provisional Application No. 62/545,150, filed on Aug. 14, 2017 and entitled RESISTANCE SPOT WELDING ENHANCED BY ELECTROMAGNETS, the content of which is hereby incorporated by reference in its entirety.

### FIELD OF THE INVENTION

This application relates to resistance spot welding, and more particularly to resistance spot welding with electromagnetics.

### BACKGROUND

Metal manufacturing can involve welding metal sheets or metal alloy sheets together to form various parts or components of a final product. Various techniques or processes, including, for example, resistance spot welding, can be used to weld the metal sheets. Resistance spot welding can involve positioning metal sheets between electrodes and using the electrodes to apply a clamping force and an electric current to the metal sheets. Heat produced from a resistance of the metal sheets to the electric current, along with the clamping force of the electrodes, can be used to join the metal sheets at the interface, forming locally cohesive zones known as weld nuggets.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

In some examples, a method of resistance spot welding includes positioning a first metal sheet and a second metal sheet between two electrodes. In some aspects, the first metal sheet includes a first aluminum alloy and/or the second metal sheet includes a second aluminum alloy. In other examples, the first metal sheet and/or the second metal sheet include a metal other than aluminum. In some non-limiting examples, the first metal sheet and/or the second metal sheet include steel. According to some cases, the method includes positioning the two electrodes on opposing surfaces of the first metal sheet and the second metal sheet and applying a current to the first metal sheet and the second metal sheet through the two electrodes to form a weld nugget. In various aspects, the method also includes stirring the portion of the first metal sheet and the second metal sheet forming the weld nugget by applying a magnetic field from an electromagnet through the weld while applying the current. In some examples, the method includes adjusting the magnetic field to control at least one of a weld strength of the weld nugget, a weld shape of the weld nugget, a weld size of the weld nugget, or a grain orientation of the weld nugget. Forming the weld nugget joins the first metal sheet with the second metal sheet.

In other examples, disclosed is a weld formed between a first metal sheet and a second metal sheet. In some examples, the weld includes a first portion having a first grain orientation and a second portion having a second grain orientation different from the first grain orientation.

In some examples, a method of resistance spot welding includes positioning a magnet carrier on at least one electrode of two electrodes where the magnet carrier comprises a plurality of electromagnets positioned around the at least one electrode. The method also includes positioning a first metal sheet and a second metal sheet between the two electrodes, where at least one of the first metal sheet or the second metal sheet comprises an aluminum alloy. The method further includes positioning the two electrodes on opposing surfaces of the first metal sheet and the second metal sheet. In various aspects, the method includes forming a weld nugget by applying a magnetic field from the plurality of electromagnets through the weld while applying a current through the electrodes to stir a portion of the first metal sheet and the second metal sheet forming a weld nugget and adjusting the magnetic field to control at least one characteristic of the weld nugget. Forming the weld nugget joins the first metal sheet with the second metal sheet.

In various examples, a method of resistance spot welding includes positioning a first metal sheet and a second metal sheet between two electrodes, where at least one of the electrodes comprises a magnet carrier comprising a plurality of electromagnets, and where at least one of the first metal sheet and the second metal sheet comprises a 7xxx series aluminum alloy. The method includes clamping the two electrodes together and applying a current to the first metal sheet and the second metal sheet through the two electrodes to form a weld nugget. In some examples, the method includes applying a magnetic field through the weld nugget through the plurality of electromagnets surrounding the two electrodes, where forming the weld nugget joins the first metal sheet with the second metal sheet.

In certain examples, a resistance spot welding system includes a magnet carrier defining a receiving passage that is configured to receive an electrode of the resistance spot welding system and a plurality of electromagnets on the magnet carrier such that the electromagnets are positioned around the electrode when the magnet carrier is positioned on the electrode.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a diagram illustrating an example of a resistance spot welding system according to aspects of the current disclosure.

FIG. 2 is a photograph of a portion of a weld nugget formed with the system of FIG. 1.

FIG. 3 is a photograph of a portion of a weld nugget formed with the system of FIG. 1.

FIG. 4 is a perspective view of an example of a resistance spot welding system according to aspects of the current disclosure.

FIG. 5 is an enlarged view of a portion of the system of FIG. 4.

FIG. 6 is a top perspective view of a magnet carriage of the system of FIG. 4.

FIG. 7 is a bottom perspective view of the magnet carriage of FIG. 6.

FIG. 8 is a schematic bottom view of the magnet carriage of FIG. 6.

FIG. 9 is a schematic sectional view of the magnet carriage of FIG. 6.

FIG. 10 is a perspective view of an example of a resistance spot welding system according to aspects of the current disclosure.

FIG. 11 is a schematic sectional view of a magnet carriage of the system of FIG. 10.

FIG. 12 is a side view of another magnet carriage including bridges between electromagnets according to aspects of the present disclosure.

FIG. 13 is a top perspective view of the magnet carriage of FIG. 12.

FIG. 14 is a bottom perspective view of the magnet carriage of FIG. 12.

FIG. 15 is a sectional view of the bridges of FIG. 12.

FIG. 16 is another sectional view of the bridges of FIG. 12.

FIG. 17 is a chart illustrating a weld growth curve of a weld nugget according to aspects of the current disclosure.

FIGS. 18A-B are charts illustrating tensile shear peak loads of weld nuggets according to aspects of the current disclosure.

FIG. 19 is a chart illustrating energy absorption of weld nuggets according to aspects of the current disclosure.

FIGS. 20A-D are photographs of a weld nuggets according to aspects of the current disclosure.

FIGS. 21A-B are scanning electron microscope (SEM) pictures of weld nuggets according to aspects of the current disclosure.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” and “back,” among others, are intended to refer to the orientation as illustrated and described in the figure (or figures) to which the components and directions are referencing.

Aspects and features of the present disclosure can be used with any suitable metal substrate, however may be especially useful for bonding aluminum and/or aluminum alloys. In this description, reference is made to alloys identified by aluminum industry designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

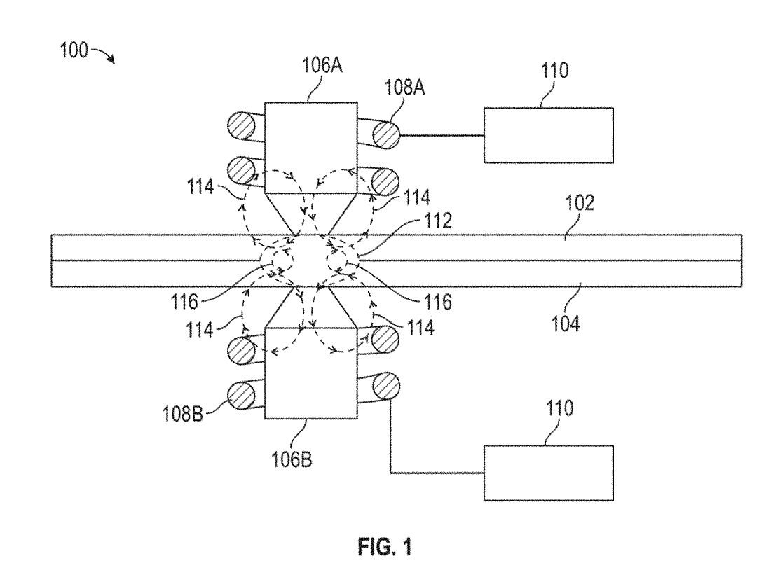

FIG. 1 illustrates an exemplary system 100 for enhanced resistance spot welding (“RSW”) of a first metal sheet 102 to a second metal sheet 104. Although two metal sheets are illustrated, in other examples more than two metal sheets may be joined through RSW. For example, three sheets, four sheets, five sheets, etc., may be joined together through the system 100. In other aspects, a metal sheet may be joined to metal products other than sheets such as castings, extrusions, etc.

In various examples, the first metal sheet 102 includes a first aluminum alloy and/or the second metal sheet 104 includes a second aluminum alloy. In such cases, the first aluminum alloy and/or the second aluminum alloy can be cast using various suitable casting methods including, but not limited to direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method. In other examples, the first metal sheet 102 and/or the second metal sheet 104 include a metal other than aluminum or an aluminum alloy. As one non-limiting example, the first metal sheet 102 includes an aluminum alloy and the second metal sheet 104 includes steel or vice versa.

In some examples, the first metal sheet 102 and/or the second metal sheet 104 may be selected from the group comprising a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy. In some examples, the first aluminum alloy is different from the second aluminum alloy (e.g., the first aluminum alloy is a 7xxx series aluminum alloy and the second aluminum alloy is a 6xxx series aluminum alloy). In other examples, the first aluminum alloy and the second aluminum alloy are both the same series aluminum alloy (e.g., both the first and second aluminum alloys are a 7xxx series aluminum alloy). In certain examples, the first aluminum alloy and the second aluminum alloy may be the same aluminum alloy (e.g., both the first and second aluminum alloys are a 7075 aluminum alloy). In other examples, the first metal sheet 102 and/or the second metal sheet 104 may be various other metals or materials to be welded together, including, but not limited to, aluminum, aluminum alloys, steel, steel-based materials, nickel, nickel-based materials, copper, copper-based materials, cast iron, titanium, titanium-based materials, various other suitable materials, and/or various combinations of materials.

In other examples, the first metal sheet 102 and/or the second metal sheet 104 may include various other metals or types of metal sheets including, but not limited to, an aluminum cladded alloy sheet, a monolithic alloy (aluminum, steel, etc.), a roll bonded alloy, or various other types of metal sheets to be welded together. In some non-limiting examples where the first metal sheet 102 includes aluminum and the second metal sheet 104 includes steel or some other dissimilar metal, the first metal sheet 102 may be brazed to the second metal sheet 104 where the second metal sheet 104 would not experience melting.

To weld the first metal sheet 102 to the second metal sheet 104, at least a portion of the first metal sheet 102 and at least a portion of the second metal sheet are positioned between electrodes 106A-B such that the first metal sheet 102 and the second metal sheet 104 at least partially overlap. Any number of electrodes 106 may be used as desired. The electrodes 106A-B are clamped together such that the electrodes contact opposing surfaces of the first metal sheet 102 and the second metal sheet 104, as illustrated in FIG. 1.

While the electrodes 106A-B are clamped together, an electric current is applied via the electrodes 106A-B. Heat is generated at the interface of the metal sheets 102 and 104 and causes the metal sheets 102 and 104 to heat up and form a weld nugget 112. As the current is applied, the weld nugget 112 grows and elongates within the metal sheets 102 and 104. When the current through the electrodes 106A-B is stopped, the molten metal forming the weld nugget may cool to form a weld. In various examples, the electric current applied is at least a minimum current to form a weld having a minimum weld size (MWS) to join the first metal sheet 102 with the second metal sheet 104. MWS is defined as 4\sqrt{T}, where t is the thickness of the governing metal thickness. In a stack of two aluminum alloy sheets, the governing metal thickness is generally the thinnest sheet. In a stack of three aluminum alloy sheets, the governing metal thickness is generally the thickness of the middle sheet. In various examples, the thickness may be any thickness that is suitable with RSW technology.

As illustrated in FIG. 1, in various examples, electromagnets 108A-B are provided around each of the electrodes 106A-B. In other examples, one or more electromagnets may be within the electrode rather than around the electrode. Electromagnets are temporary magnets, meaning that they only retain their magnetism when an electrical current is running through them. While electromagnets 108A-B are illustrated, in other examples, other types of permanent magnets or temporary magnets, such as stationary, rotating, or moving permanent magnets, may be used to provide a mobile magnetic field. Similar to the electromagnets, the permanent magnets or temporary magnets may be provided around the electrode or within the electrode. As some non-limiting examples, a ring-shaped permanent magnet may be provided that surrounds the electrode. In some examples, the electromagnets 108A-B are electromagnetic coils.

In some examples, the upper electromagnet 108A may contact the surface of the first metal sheet 102 and the lower electromagnet 108B may contact the second metal sheet 104 during RSW. Optionally, the electromagnets 108A-B contact the metal sheets 102, 104 without scratching the respective sheets. In certain examples, contact between the electromagnets and the metal sheets 102, 104 may maximize the stirring effects described below. In other examples, the electromagnets 108A-B are spaced apart from the respective metal sheets 102, 104.

The electromagnets 108A-B are each connected to a power source 110 that supplies an electric current (which may or may not be different from the current applied to the electrodes 106A-B to form the weld) to the respective electromagnet 108A-B. Although two power sources 110 are illustrated, any number of power sources 110 may be utilized, including a single power source that supplies the electric current to both electromagnets 108A-B. In some examples, the power sources 110 are direct current (“DC”) power sources, although various other suitable power sources may be utilized (e.g., alternating current (“AC”) power sources or other suitable power sources). When the power sources 110 are DC power sources, one electrode (e.g. electrode 106A) is positive and the other electrode (e.g., electrode 106B) is negative.

While the electric current is supplied to the electromagnets 108A-B, the electromagnets 108A-B create magnetic fields 114. As illustrated in FIG. 1, these magnetic fields 114 cause stirring (represented by arrows 116) of the molten metal within the weld nugget 112. In some examples stirring of the molten metal in the weld nugget 112 may minimize or reduce the segregation or depletion in the center area of the weld nugget 112. In some non-limiting examples where the metal sheets 102, 104 are aluminum, stirring the molten metal in the weld nugget 112 may minimize or reduce the depletion of silicon in the center of the weld nugget 112. In certain examples, minimizing or reducing the segregation or depletion in the center area of the weld nugget 112, hot cracking of the weld nugget 112 may be minimized. As described in detail below, in various examples, the electromagnets may have the same polarity facing the weld nugget 112, different polarities facing the weld nugget 112, or various combinations of polarities facing the weld nugget 112. In some examples, when the polarities are all the same towards the weld nugget 112, the magnetic flux may curve around and the stirring effect may be achieved around the edge of the weld nugget 112. In various examples, when the polarities are different towards the weld, the magnetic flux may pass through the weld and the stirring effect may be achieved in the middle of the weld nugget 112. Stirring in the middle of the weld nugget 112 may optionally address cracking and porosities otherwise observed in RSW.

When the electric current to the electromagnets is stopped, the magnetic fields 114 disappear. By using the electromagnets 108A-B, the magnetic fields 114 can be quickly changed or adjusted such that stirring of the molten metal within the weld nugget 112 can be quickly changed or adjusted. In various examples, the magnetic fields 114 are adjusted during RSW to produce welds with improved weld strength, weld shape, weld size, grain refinement, weld quality, and/or weld fatigue performance. Exemplary techniques for adjusting the magnetic fields 114 are described below. These techniques may be used individually or in various combinations (or with other suitable techniques) to produce welds having a desired weld strength, weld shape, weld size, grain refinement, weld quality, and/or weld fatigue performance. The magnetic fields 114 may be modulated or controlled concurrently or separately. As one non-limiting example, the magnetic fields 114 may be modulated separately if the first metal sheet 102 and the second metal sheet 104 are dissimilar metals, or dissimilar alloys, have different thicknesses, among others, although they need not be. In some cases, only one electromagnet 108A-B may be activated.

In various examples, adjusting the magnetic fields 114 includes controlling an amount of current provided to the electromagnets 108A-B. In various examples, controlling the amount of current provided to the electromagnets 108A-B includes controlling or adjusting a design of the coils of the electromagnets 108A-B. In some examples, controlling the amount of current includes increasing the amount of current provided to the electromagnets 108A-B to increase the magnetic fields 114, which in turn increases the stirring (e.g., the rate of stirring, the amount of the weld nugget 112 that is stirred, etc.) within the weld nugget 112. In other examples, controlling the amount of current includes decreasing the amount of current provided by the electromagnets 108A-B to decrease the magnetic fields 114, which in turn decreases the stirring within the weld nugget 112. In some non-limiting examples, the current may be from about 0 amps to about 1000 amps. In various other examples, the current may be greater than about 1000 amps.

In some examples, adjusting the magnetic fields 114 includes controlling a current supply time, which is the duration of time in which the current is supplied from the power sources 110 to the electromagnets 108A-B. In one non-limiting example, the duration of time in which the current is supplied may be from about 0 ms to about 100 ms. In other examples, the current may be greater than 100 ms. In other non-limiting examples, the duration of time may be from about 16 ms to about 2000 ms. Because the magnetic fields 114 are only present while the current is provided to the electromagnets 108A-B, adjusting the current supply time adjusts the amount of time that the weld nugget 112 is stirred through the magnetic fields 114. In some examples, controlling the current supply time includes decreasing the current supply time to decrease the amount of time that the weld nugget 112 is stirred. In other examples, controlling the current supply time includes increasing the current supply time to increase the amount of time that the weld nugget 112 is stirred. In various examples, adjusting the magnetic fields 114 includes both controlling the current supply time and controlling the amount of current provided to the electromagnets 108A-B.

In certain examples, adjusting the magnetic fields 114 includes pulsing the current provided to the electromagnets 108A-B. Pulsing the current may include alternating the amount of current provided in a regular or irregular pattern, alternating periods in which the current is activated or “on” and deactivated or “off” in a regular or irregular pattern, or other desired regular or irregular patterns where at least one aspect of the current is adjusted. In various examples, pulsing the current may introduce an unsteady flow regime within the weld nugget, which may minimize or prevent elongated grain structure development within the weld nugget.

In some examples, adjusting the magnetic fields 114 includes oscillation of the magnetic fields 114. Oscillation of the magnetic fields 114 may introduce stirring and light convection within the weld nugget.

In various cases, adjusting the magnetic fields 114 includes reversing the magnetic fields 114. In some aspects, reversing the magnetic fields 114 includes changing the direction of flow of the electric current.

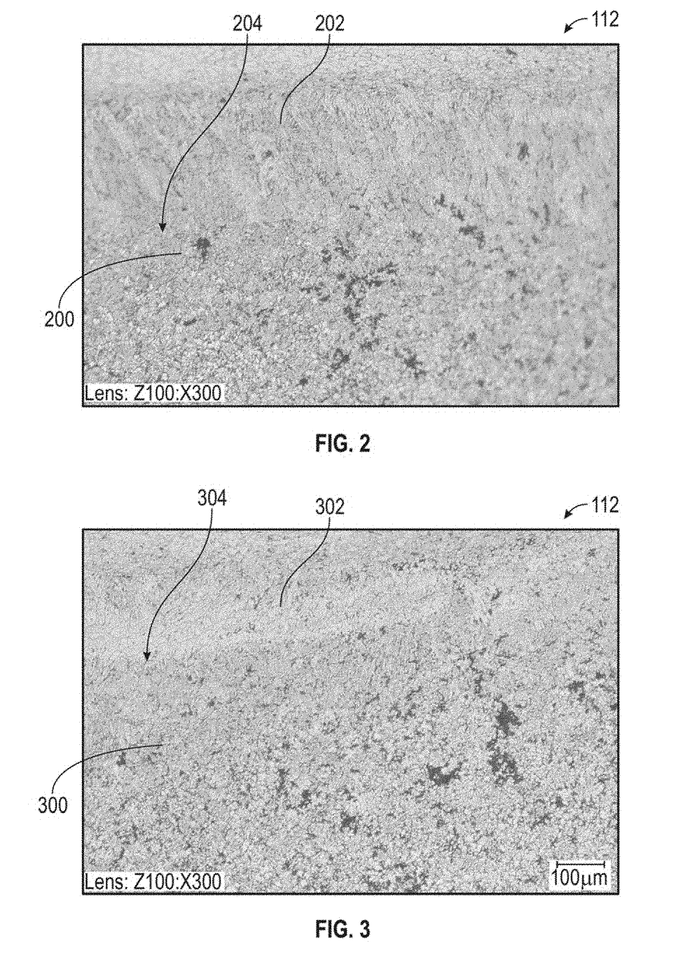

In various examples, the magnetic fields 114 are adjusted (e.g., by pulsing, reversing, adjusting the power, etc.) such that a first portion of the weld nugget 112 has a first grain orientation and a second portion of the weld nugget 112 has a second grain orientation different from the first grain orientation. As one non-limiting example, in some examples, an inner layer of the weld nugget 112 (i.e., closer to a center of the weld nugget 112) has a first grain orientation and an outer layer of the weld nugget 112 (i.e., closer to the outer edge of the weld nugget 112 or further from the center of the weld nugget 112) has a second grain orientation different from the first grain orientation. In some examples, controlling the grain orientation of the weld nugget 112 such that it has at least two grain orientations may increase the weld's resistance to cracking. Non-limiting examples of a weld nugget 112 are illustrated in FIGS. 2 and 3. As illustrated in FIG. 2, a first portion 200 has a first grain orientation and a second portion 202 has a second grain orientation such that a grain boundary 204 is formed. Similarly, in FIG. 3, a first portion 300 has a first grain orientation and a second portion 304 has a second grain orientation such that a grain boundary 304 is formed. As one non-limiting example, compared to a crack in a weld having a substantially uniform grain orientation, a weld having at least two grain orientations may limit or slow crack propagation because the grain orientations are different. In some examples, a finer grain structure exhibits higher strengths, and irregular grain structures slow down crack propagation by inhibiting intergranular failure, which forces the crack to then propagate transgranularly.

In FIG. 1, the electrode 106A includes an electromagnet 108A (the coil of the electromagnet 108A is shown in sectional form for clarity). Similarly, the electrode 106B includes an electromagnet 108B. It will be appreciated that in other examples, the electromagnet 108A and/or the electromagnet 108B may be omitted from the system 100. As such, in the system 100, when the electromagnets 108A-B are activated, each electromagnet 108A-B provides a single magnetic pole that is utilized to control or adjust the formation of the weld nugget 112 during the RSW process. In the example illustrated in FIG. 1, the pole of each electromagnet 108 that is utilized to control or adjust the formation of the weld nugget 112 is at the end of the electromagnet 108 facing the weld or the sheets to be welded. In other examples, multiple magnetic poles may be provided around each of the electrodes 106A-B to control or adjust the formation of the weld nugget 112 as described below.

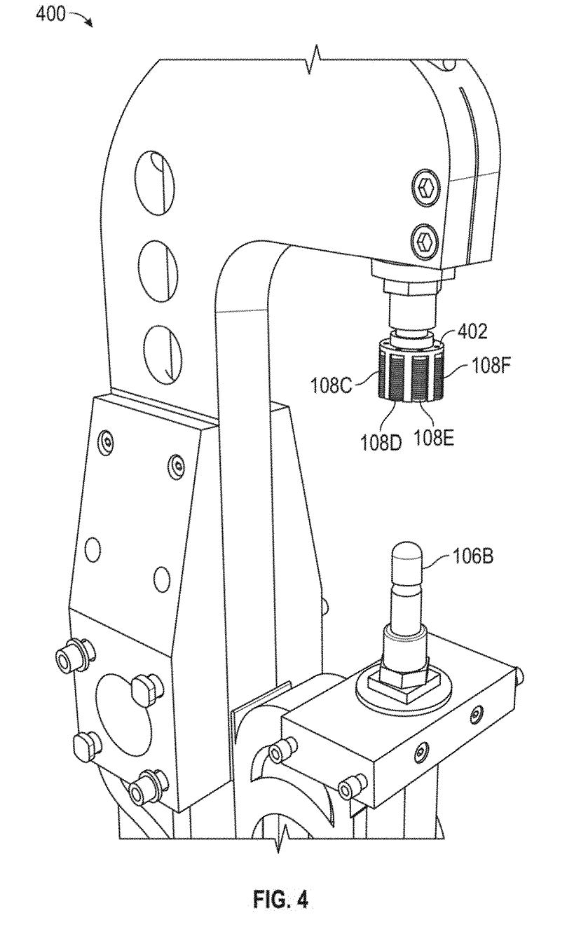

FIGS. 4-9 illustrate an example of an enhanced RSW system 400 that is substantially similar to the system 100 except that the RSW system 400 includes multiple magnetic poles provided around at least one of the electrodes 106A-B.

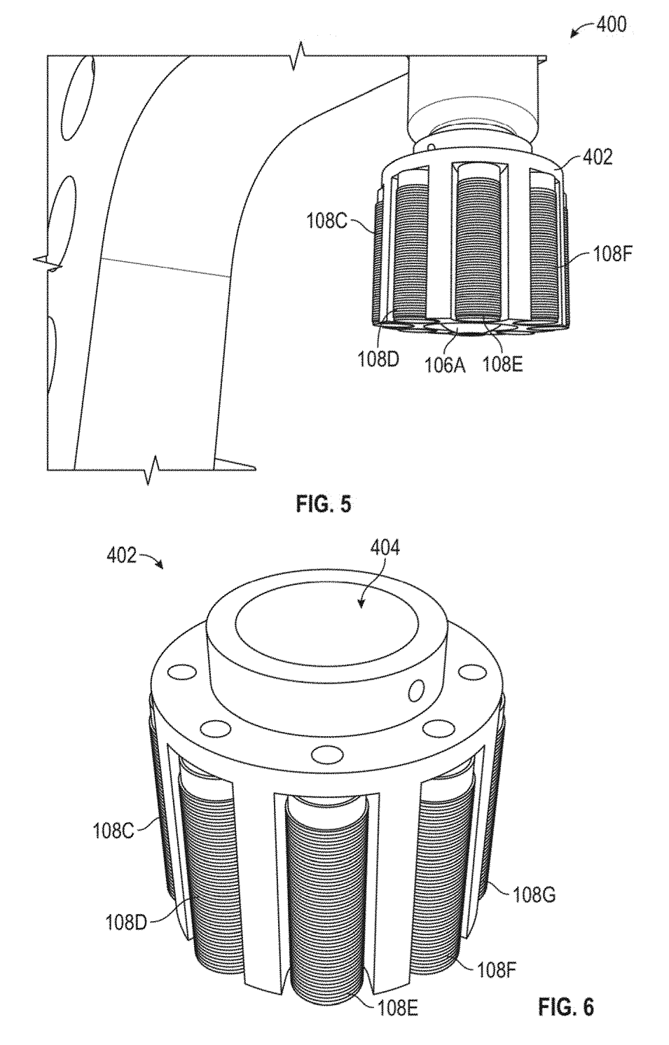

In various examples, the system 400 includes a magnet carrier 402 that accommodates a plurality of electromagnets 108. As best illustrated in FIGS. 6-9, the magnet carrier 402 defines a receiving passage 404 within which the electrode 106 is positioned when the magnet carrier 402 is positioned on the electrode 106. In the example illustrated in FIGS. 4 and 5, the magnet carrier 402 is provided on the electrode 106A; however, in other examples, the magnet carrier 402 may be provided on the electrode 106B or magnet carriers 402 may be provided on both of the electrodes 106A-B.

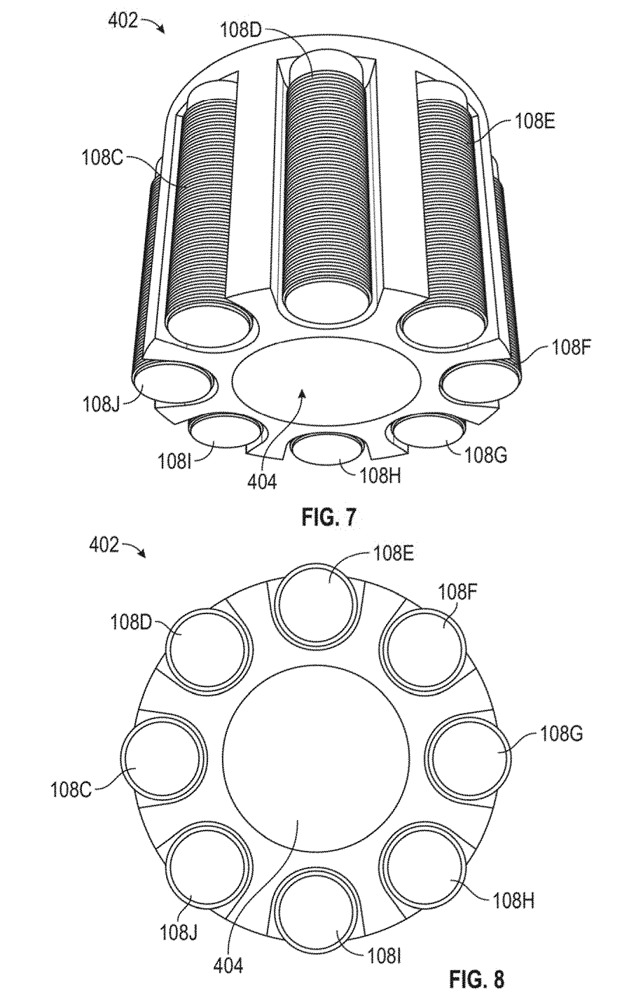

In the example illustrated in FIGS. 4-9, the magnet carrier 402 includes eight (8) electromagnets 108C-J; however, in other examples, the magnet carrier 402 may include any desired number of electromagnets 108. For example, the magnet carrier 402 may include one electromagnet, two electromagnets, three electromagnets, four electromagnets, five electromagnets, six electromagnets, seven electromagnets, or more than eight electromagnets. As best illustrated in FIGS. 7 and 8, in various examples, the electromagnets 108 are spaced equidistantly around the receiving passage 404, although in other examples, they need not be. The electromagnets 108 may be fixedly secured to the magnet carrier 402 or may be removably secured to the magnet carrier 402. Depending of particular need or situation, various aspects of the electromagnet (e.g., diameter, current, wiring, etc.) may be controlled and/or adjusted as desired.

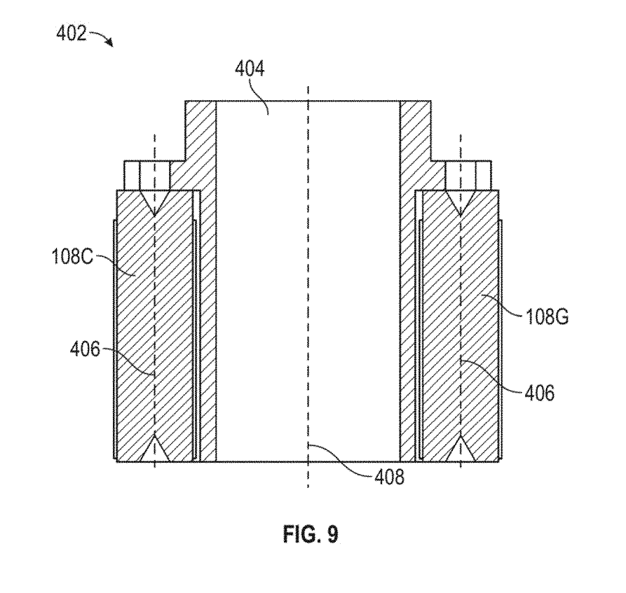

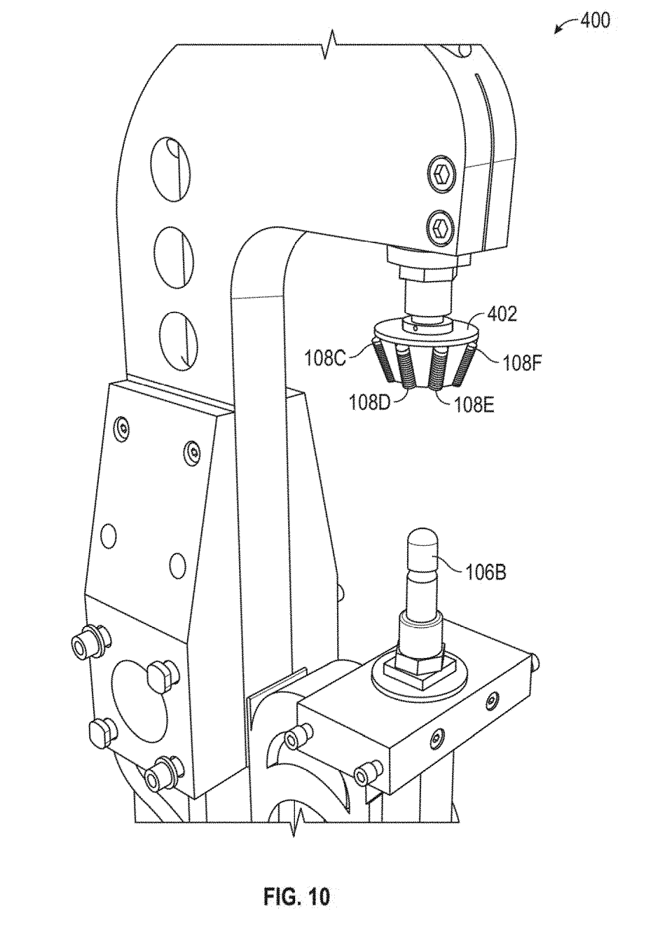

In certain aspects, the electromagnets 108 are positioned on the magnet carrier 402 such that a central axis 406 of each electromagnet 108 (see FIG. 9) is substantially parallel to a central axis 408 of the receiving passage 404 (see FIG. 9). In other examples, the electromagnets 108 are positioned on the magnet carrier 402 such that the central axis 406 of each electromagnet 108 is angled with respect to the central axis 408 of the receiving passage 404 (see FIGS. 10 and 11). In various examples, the central axis 406 of each electromagnet 108 may be at an angle of from about 0° to about 90° with respect the central axis 408 of the receiving passage 404. As some non-limiting examples, the angle may be about 1°, about 2°, about 3°, about 4°, about 5°, about 6°, about 7°, about 8°, about 9°, about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, about 35°, about 36°, about 37°, about 38°, about 39°, about 40°, about 41°, about 42°, about 43°, about 44°, about 45°, about 46°, about 47°, about 48°, about 49°, about 50°, about 51°, about 52°, about 53°, about 54°, about 55°, about 56°, about 57°, about 58°, about 59°, about 60°, about 61°, about 62°, about 63°, about 64°, about 65°, about 66°, about 67°, about 68°, about 69°, about 70°, about 71°, about 72°, about 73°, about 74°, about 75°, about 76°, about 77°, about 78°, about 79°, about 80°, about 81°, about 82°, about 83°, about 84°, about 85°, about 86°, about 87°, about 88°, about 89°, and/or about 90°. In other examples, other angles may be utilized. Depending on desired stirring characteristics, the poles of the electromagnets 108 are angled inward and towards the central axis 408 or outwards and away from the central axis 408.

In some examples, the central axis 406 of each electromagnet 108 is at the same angle with respect to the central axis 408. In other examples, the angle of the central axis 406 of one electromagnet 108 may be different from the angle of the central axis 406 of another electromagnet 108. In some aspects, the angle of the central axis 406 with respect to the central axis 408 of the receiving passage 404 is static such that if a user wants to change the orientation of the electromagnets from a parallel orientation (or 90° angle with respect to the horizontal axis) to a non-parallel or angled orientation with respect to the central axis 408, one magnet carrier 402 is removed from the electrode 106 and another magnet carrier 402 is installed on the electrode 106. In other examples, the magnet carrier 402 is adjustable such that an angle of each electromagnet 108 can be controlled and adjusted as desired. For example, in some cases, each electromagnet 108 may be adjustable through a hinge, a pivoting connection, a change in height of the electrode, an adjustable ring, a flower or petal mechanism, or various other suitable mechanisms.

In some examples, during RSW, at least one of the electromagnets 108 around the upper electrode 106A may contact the first metal sheet 102 and at least one of the electromagnets 108 around the lower electrode 106B may contact the second metal sheet 104. As previously described, in some examples, contact between the electromagnets 108 and the metal sheets 102, 104 may optionally maximize stirring effects in the weld nugget. In other examples, the electromagnets 108 are spaced apart from the metal sheets 102, 104.

FIGS. 10 and 11 illustrate the RSW system 400 with the central axis 406 of each electromagnet at a non-parallel angle with respect to the central axis 408.

In various examples, a method of resistance spot welding with the RSW system 400 includes positioning the magnet carrier 402 on at least one of the electrodes 106A-B. The method then includes positioning the first metal sheet 102 and the second metal sheet 104 between the electrodes 106A-B, positioning the two electrodes 106A-B on opposing surfaces of the first metal sheet 102 and the second metal sheet 104, and applying a current to the first metal sheet 102 and the second metal sheet 104 through the two electrodes 106A-B to form the weld nugget 112. The method also includes stirring the portion of the first metal sheet 102 and the second metal sheet 104 forming the weld nugget 112 by applying and controlling magnetic fields from electromagnets 108 on the magnet carrier 402 through the weld nugget 112 while applying the current.

In some examples, applying and controlling the magnetic fields from the electromagnets 108 on the magnet carrier 402 include setting each electromagnet 108 to an initial polarity. For example, the electromagnets may be set to all have a north (N) polarity, a south (S) polarity, or a combination thereof. In one non-limiting example, all poles of the electromagnets 108 may initially be set to the S polarity. In other non-limiting examples, all poles of the electromagnets 108 may be initially set to the N polarity or any combination of S and N polarities. At a predetermined time during the weld cycle, the polarities of the electromagnets 108 are swapped in a predetermined pattern at a predetermined speed for a predetermined stirring time period. The predetermined time may be a time before welding begins, during welding, or after welding. In some non-limiting examples, the predetermined time period may be from about 0.5 seconds before welding begins to about 1 second after welding ends. In other examples, the predetermined time may be a time period more than about 0.5 seconds before welding begins or more than about 1 second after welding ends. Optionally, in some examples, the electromagnets are activated prior to the peak welding current shut down to minimize potential negative effects of the extra magnetic fields on the welding-current induced magnetic field.

In various examples, the predetermined speed or frequency may be from about 0 Hz (or static) to about 30 kHz, such as from about 0 Hz to about 20 kHz. In some non-limiting examples, the predetermined stirring time period may be from about 250 ms to about 500 ms, although in other examples, the predetermined time period may be less than 250 ms or greater than 500 ms. As used herein, the predetermined speed or frequency of the pattern refers to how often each electromagnet is adjusted, whereas the predetermined stirring time period refers to how long the pattern is applied.

As one non-limiting example, at the predetermined time period, the polarity of one electromagnet 108 (e.g., the electromagnet 108C) is reversed from S polarity to N polarity, and then at the predetermined speed or frequency, the polarities of the other electromagnets (e.g., electromagnets 108D-J) are sequentially reversed in a stepped pattern (i.e., the polarity of the electromagnet 108D is reversed, then the polarity of the electromagnet 108E is reversed, etc.). The pattern of reversing the polarities of the electromagnets 108 continues for the predetermined stirring time period. It will be appreciated that various other patterns of swapping the polarities of the electromagnets 108 may be utilized to control stirring of the weld nugget 112. As some non-limiting examples, the pattern may be static (e.g., the electromagnets are all activated at once and the polarity is not changed after activation), may include activating electromagnets on opposite sides of the electrode, may include swapping the polarity of every other electromagnet 108, swapping every third electromagnet 108, swapping every fourth electromagnet 108, changing a random electromagnet 108, and various other patterns as desired.

Accordingly, in various examples, the stirring of the weld nugget 112 may be controlled with the system 400 by adjusting or controlling the pattern in which the polarities of the electromagnets 108 are changed. Stirring of the weld nugget 112 may also be controlled by adjusting or controlling the predetermined speed or frequency of the pattern (i.e., how often each electromagnet is adjusted), the predetermined stirring time period (i.e., how long the pattern is applied for), the predetermined time during the weld cycle at which the pattern is first started, an angle of the central axis 406 of each electromagnet 108, a number of electromagnets 108 on the magnet carrier 402, a current scheme for the electromagnets 108 (e.g., ramping up, ramping down, pulsations, etc.), a timing of ramping current up and down, and a diameter of each electromagnet 108, among others.

In some examples, applying and controlling the magnetic fields from the electromagnets 108 on the magnet carrier 402 includes activating the electromagnets 108 such that the direction of the stirring of the weld nugget 112 is controlled. For example, in some cases, the electromagnets 108 are controlled such the molten metal forming the weld nugget 112 is stirred in a circular path, in a vertical direction, or in various other paths or patterns as desired. In some examples, the path of the stirring is controlled to bring those eutectic to heal voids or other cracked regions in the sheets 102, 104 to minimize the solidification cracking and void formation at the last stage of the molten metal solidification.

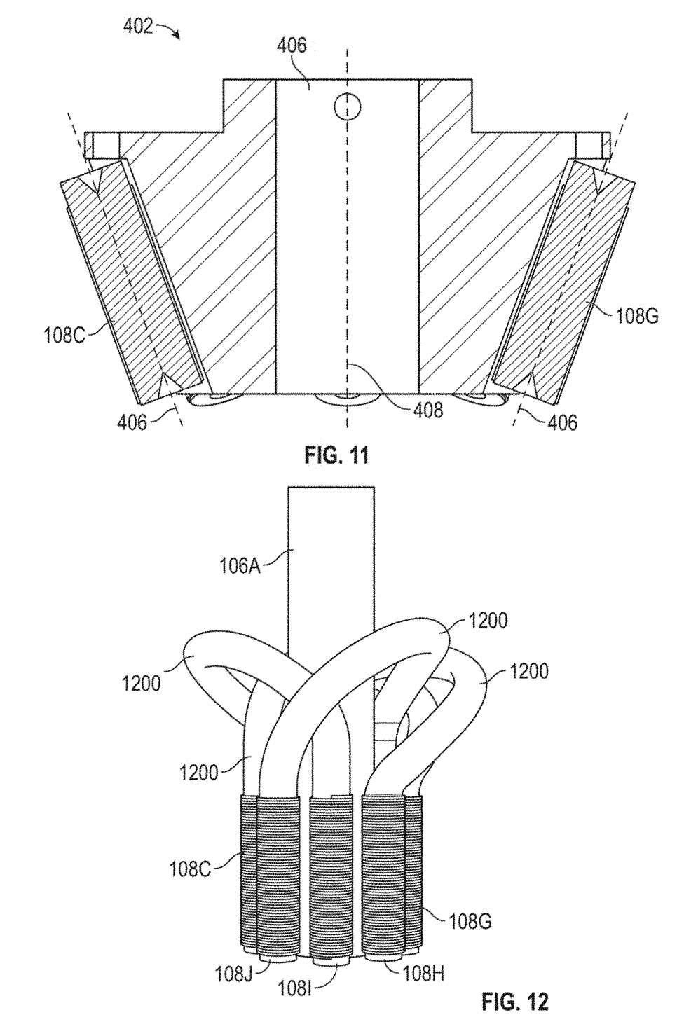

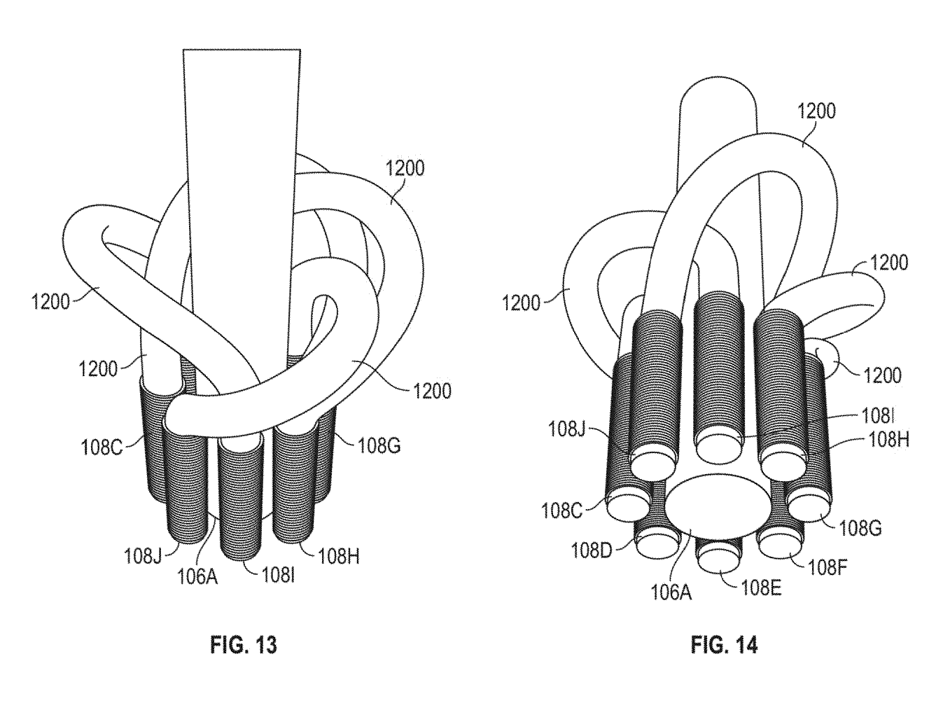

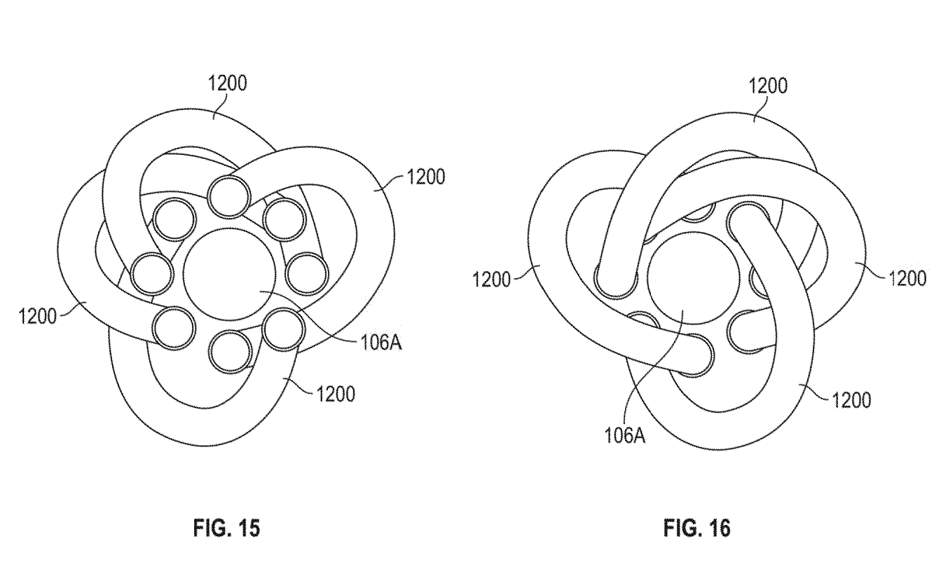

FIGS. 12-16 illustrate another example of a RSW system that is substantially similar to the RSW system 400 except that bridges 1200 connecting at least two electromagnets are provided. In some examples, the bridges 1200 are configured to guide the flow of the magnetic fields and concentrate the location of the magnetic fields (e.g., to the weld nugget 112). In certain examples, the bridges 120 may be steel, iron, or various other suitable materials. In certain examples, the bridges 120 may connect at least any two electromagnets. Optionally, the connected electromagnets 108 are on opposite sides of the magnet carrier, although they need not be. In the example illustrated in FIGS. 12-16, one bridge 1200 connects electromagnets 108C and 108G, another bridge 1200 connects electromagnets 108D and 108H, one bridge 1200 connects electromagnets 108E and 108I, and another bridge 1200 connects electromagnets 108F and 108J.

Welds formed with any of the systems or methods of the present disclosure may be improved compared to traditional welds without external magnetic fields. As some examples, welds formed according to aspects of the present disclosure may have increased weld strength, increased energy absorption, increased weld range, may require a lower minimum current, may have a more refined microstructure, increased mechanical performance, and/or may have a reduction in cracks and/or pores, among other benefits. As one non-limiting example, welds according to aspects of the present disclosure may have approximately a 15-25% increase in weld peak strength. As another non-limiting example, welds according to aspects of the present disclosure may have approximately a 30-70% increase in energy absorption in tensile shear. As a further non-limiting examples, welds according to aspects of the present disclosure may have a weld range that is increased by approximately 2-3 kA, meaning that the system provides a larger welding working window/range of currents to produce acceptable welds. As an additional non-limiting example, welds according to aspects of the present disclosure may need a minimum current that is approximately 5 kA less than traditional welding systems to achieve an acceptable weld size. In certain examples, a lower current for an acceptable weld size may mean that for a given current level, larger nuggets are achievable compared to traditional welding, and larger weld nuggets infer higher weld strength. A lower current also may infer increased tip life at a specified weld size. The aforementioned examples should not be considered limiting on the current disclosure.

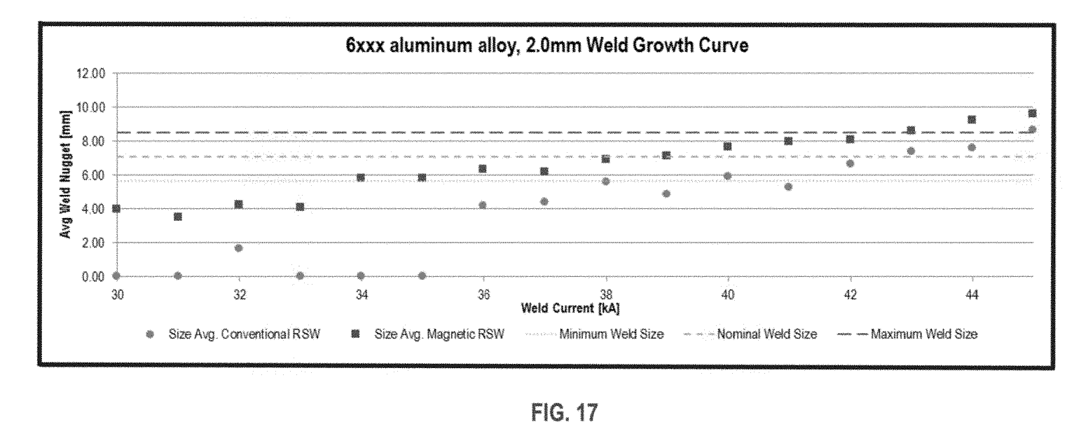

FIG. 17 is a chart illustrating an exemplary weld growth curve of a weld nugget formed in a 6111 aluminum alloy sheet with the RSW system of the current disclosure (represented by the squares in the chart) and a weld growth curve of a weld nugget formed in the same 6111 aluminum alloy with a traditional RSW system without external magnetic fields (represented by the circles in the chart). The chart indicates the current in each growth curve at which the MWS was formed (i.e., the “minimum weld size” in FIG. 17), as well as currents at weld sizes 5\sqrt{t} (i.e., the “nominal weld size” in FIG. 17) and 6\sqrt{t} (i.e., the “maximum weld size” in FIG. 17). As illustrated, the weld growth curve with the system of the current disclosure produced welds having the MWS at a current of about 34 kA, whereas the weld growth curve of the traditional RSW system did not produce welds having the MWS until a current of about 38 kA was applied. In addition, the weld growth curve with the system of the current disclosure produced a weld having the 6\sqrt{t} weld size at about 43 kA, while the weld growth curve of the traditional RSW system produced a weld having the 6\sqrt{t} weld size at about 45 kA.

A weld envelope or weld growth curve generally includes the currents sufficient for forming at least the MWS to join the sheets 102 and 104 up to currents where metal expulsion and/or surface cracks may occur (or other defects in the weld). As illustrated in FIG. 17, the weld envelope of the weld growth curve with the system of the current disclosure (ranging from about 34 kA to about 45 kA) was expanded compared to weld envelope of the weld growth curve of the traditional RSW system (ranging from about 38 kA to about 45 kA). With the expanded weld envelope, more currents may be utilized to produce welds having the MWS. Additionally, the RSW system according to the present disclosure was able to produce the MWS at a lower current, and for a given current level, larger weld nuggets were achieved, which infers a higher strength weld and an increased tip life at a specified weld size.

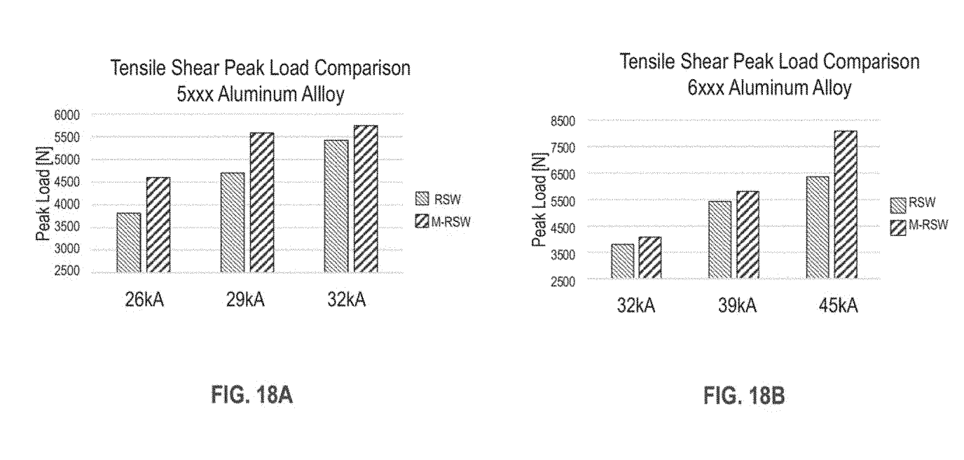

FIGS. 18A-B are charts illustrating tensile shear peak loads of weld nuggets. FIG. 18A illustrates a chart comparing the tensile shear peak loads of welds formed in a 5182 aluminum alloy using different currents, and FIG. 18B illustrates a chart comparing the tensile shear peak loads of welds formed in a 6111 aluminum alloy using different currents. As illustrated in these figures, the tensile shear peak load in welds formed with RSW systems according to the current disclosure (labeled “M-RSW” in FIGS. 18A-B) was generally increased compared to welds formed with traditional RSW systems (labeled “RSW” in FIGS. 18A-B) for a given current, which means that the welds formed with RSW systems according to the current disclosure had an increased mechanical performance.

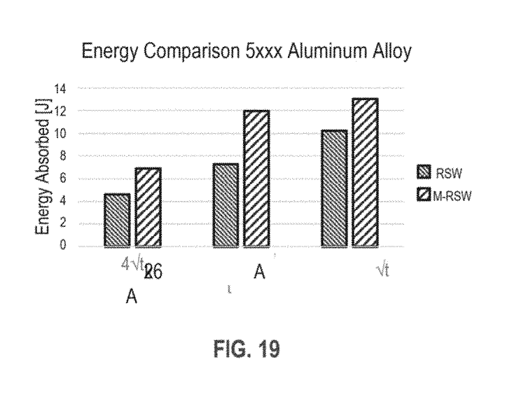

FIG. 19 is a chart illustrating energy absorption of weld nuggets formed in a 5182 aluminum alloy using the RSW system according to the current disclosure (labeled “M-RSW” in FIG. 19) and a traditional RSW system (labeled “RSW” in FIG. 19) at different currents. As illustrated in FIG. 19, at a given current, the welds formed using the RSW system according to the current disclosure had an increase energy absorption, which means that more energy is needed to pull the welds apart (i.e., the welds are stronger).

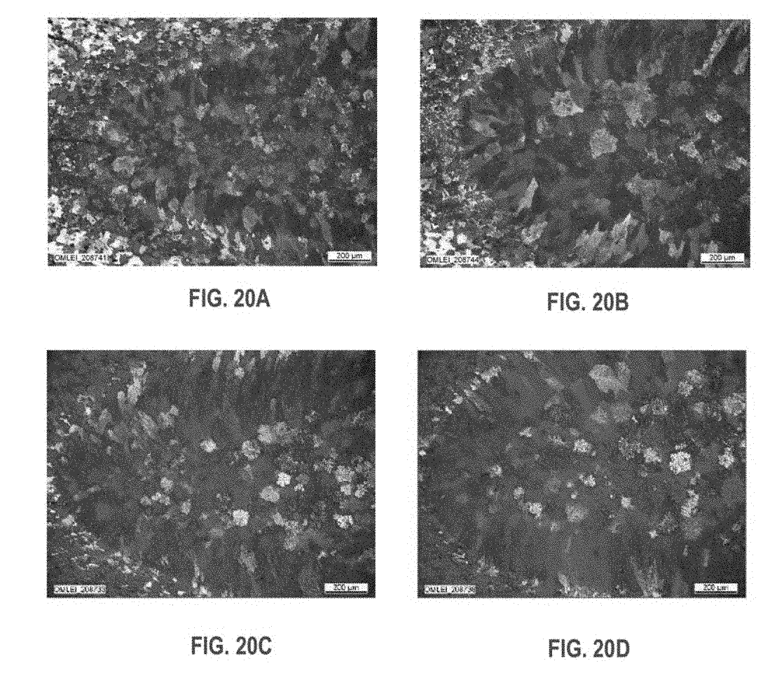

FIGS. 20A-D are photographs of grain refinement of welds forming with RSW systems of the current disclosure and welds formed with traditional RSW systems. FIG. 20A is a photograph of grain refinement in a weld formed in a 5182 aluminum alloy using RSW systems of the current disclosure, and FIG. 20B is a photograph of grain refinement in a weld formed in a 5182 aluminum alloy using a traditional RSW system. FIG. 20C is a photograph of grain refinement in a weld formed in a 6111 aluminum alloy using RSW systems of the current disclosure, and FIG. 20C is a photograph of grain refinement in a weld formed in a 6111 aluminum alloy using a traditional RSW system. As illustrated by comparing FIG. 20A to FIG. 20B and by comparing FIG. 20C to FIG. 20D, the weld nuggets formed using the RSW systems according to the current disclosure (FIGS. 20A and 20C) had a refined grain size compared to weld nuggets formed using traditional RSW systems (FIGS. 20B and 20D). Finer grain refinement may aid in reducing crack propagation through the weld, and as such produces a stronger weld.

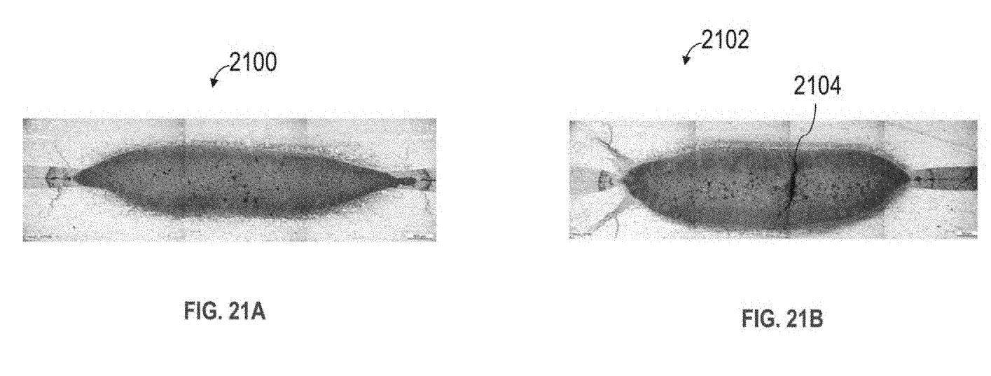

FIGS. 21A-B are SEM pictures of a weld nugget 2100 formed in a 6111 aluminum alloy with RSW systems according to the current disclosure (FIG. 21A) and a weld nugget 2102 formed in a 6111 aluminum alloy with a traditional RSW system (FIG. 21B). As illustrated in by comparing FIG. 21A to FIG. 21B, while the weld nugget 2102 has a crack 2104 and a number of pores, the weld nugget 2100 has no cracks and reduced pores/porosity, which suggests that the RSW system according to the present disclosure helps suppress the formation of cracks and pores in a weld nugget. It is believed that the mixing of the weld nugget during formation with the RSW system of the current disclosure allows for molten metal to penetrate any cracks that may form to heal or remove the cracks from the weld. In addition, by comparing FIG. 21A to FIG. 21B, the weld 2100 is more pancake-shaped and has a greater diameter, resulting in the penetration of the weld being less than the penetration of the weld 2102. It is believed that the diameter of the weld is more influential on weld strength than the weld penetration.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A method of resistance spot welding comprising: positioning a first metal sheet and a second metal sheet between two electrodes, wherein the first metal sheet comprises a first aluminum alloy and the second metal sheet comprises a second aluminum alloy; positioning the two electrodes on opposing surfaces of the first metal sheet and the second metal sheet; applying a current to the first metal sheet and the second metal sheet through the two electrodes to form a weld nugget; and stirring a portion of the first metal sheet and the second metal sheet forming the weld nugget by applying a magnetic field from an electromagnet through the weld while applying the current, wherein forming the weld nugget joins the first metal sheet with the second metal sheet.

EC 2. The method of any of the preceding or subsequent example combinations, wherein applying the magnetic field comprises activating a DC power source connected to the electromagnet such that the electromagnet generates the magnetic field.

EC 3. The method of any of the preceding or subsequent example combinations, further comprising adjusting the magnetic field to control at least one of a weld strength of the weld nugget, a weld shape of the weld nugget, a weld size of the weld nugget, or a grain orientation of the weld nugget.

EC 4. The method of any of the preceding or subsequent example combinations, wherein adjusting the magnetic field comprises adjusting a current supplied by a DC power source to the electromagnet.

EC 5. The method of any of the preceding or subsequent example combinations, wherein adjusting the current comprises pulsing the current supplied by the DC power source.

EC 6. The method of any of the preceding or subsequent example combinations, wherein adjusting the current comprises reducing the current supplied by the DC power source.

EC 7. The method of any of the preceding or subsequent example combinations, wherein adjusting the current comprises adjusting a current supply time.

EC 8. The method of any of the preceding or subsequent example combinations, wherein adjusting the current supply time comprises reducing the current supply time.

EC 9. The method of any of the preceding or subsequent example combinations, wherein the current supply time is from about 0 ms to about 100 ms.

EC 10. The method of any of the preceding or subsequent example combinations, wherein adjusting the magnetic field comprises reversing the magnetic field.

EC 11. The method of any of the preceding or subsequent example combinations, wherein the current is from about 0 amps to about 1000 amps.

EC 12. The method of any of the preceding or subsequent example combinations, wherein the electromagnet comprises a first coil for a first electrode of the two electrodes and a second coil for a second electrode of the two electrodes.

EC 13. The method of any of the preceding or subsequent example combinations, wherein the first aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy, and wherein the second aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy.

EC 14. The method of any of the preceding or subsequent example combinations, wherein the first aluminum alloy is different from the second aluminum alloy.

EC 15. The method of any of the preceding or subsequent example combinations, wherein the first aluminum alloy and the second aluminum alloy are the same series aluminum alloy.

EC 16. The method of any of the preceding or subsequent example combinations, wherein the first aluminum alloy and the second aluminum alloy are both a 7xxx series aluminum alloy.

EC 17. The method of any of the preceding or subsequent example combinations, wherein the first aluminum alloy and the second aluminum alloy are the same aluminum alloy.

EC 18. The method of any of the preceding or subsequent example combinations, further comprising adjusting the magnetic field such that a first portion of the weld nugget has a first grain orientation and a second portion of the weld nugget has a second grain orientation different from the first grain orientation.

EC 19. A weld formed by the method of any of the preceding or subsequent example combinations.

EC 21. A method of resistance spot welding comprising: positioning a first metal sheet and a second metal sheet between two electrodes, wherein the first metal sheet comprises a first aluminum alloy and the second metal sheet comprises a second aluminum alloy, and wherein at least one of the first aluminum alloy and the second aluminum alloy comprises a 7xxx series aluminum alloy; clamping the two electrodes together; applying a current to the first metal sheet and the second metal sheet through the two electrodes to form a weld nugget; and applying a magnetic field through the weld nugget through a coiled temporary electromagnet surrounding the two electrodes, wherein forming the weld nugget joins the first metal sheet with the second metal sheet.

EC 22. The method of any of the preceding or subsequent example combinations, wherein applying the magnetic field causes stirring within the portion of the first metal sheet and the second metal sheet forming the weld nugget, and wherein the method further comprises adjusting the magnetic field to adjust the stirring.

EC 23. The method of any of the preceding or subsequent example combinations, wherein adjusting the magnetic field comprises at least one of adjusting a current supplied by a DC power source to the electromagnet, adjusting a current supply time from the DC power source, or reversing the magnetic field.

EC 24. The method of any of the preceding or subsequent example combinations, wherein the current is adjusted such that a first portion of the weld nugget has a first grain orientation and a second portion of the weld nugget has a second grain orientation different from the first grain orientation.

EC 25. A weld formed by the method of any of the preceding or subsequent example combinations.

EC 26. A method of resistance spot welding comprising: positioning a magnet carrier on at least one electrode of two electrodes, the magnet carrier comprising a plurality of electromagnets positioned around the at least one electrode; positioning a first metal sheet and a second metal sheet between the two electrodes, wherein at least one of the first metal sheet or the second metal sheet comprises an aluminum alloy; positioning the two electrodes on opposing surfaces of the first metal sheet and the second metal sheet; and forming a weld nugget by: applying a magnetic field from the plurality of electromagnets through the weld while applying a current through the electrodes to stir a portion of the first metal sheet and the second metal sheet forming a weld nugget; and adjusting the magnetic field to control at least one characteristic of the weld nugget, wherein forming the weld nugget joins the first metal sheet with the second metal sheet.

EC 27. The method of any of the preceding or subsequent example combinations, wherein adjusting the magnetic field comprises controlling an angle of a central axis of at least one electromagnet of the plurality of electromagnets with respect to a central axis of the at least one electrode.

EC 28. The method of any of the preceding or subsequent example combinations, wherein controlling the angle of the central axis of the at least one electromagnet comprises angling the central axis of the at least one electromagnet such that the central axis of the at least one electromagnet is parallel to the central axis of the at least one electrode, a pole of the at least one electromagnet is angled inwards and towards the at least one electrode, or the pole of the at least one electromagnet is angled outwards and away from the at least one electrode.

EC 29. The method of any of the preceding or subsequent example combinations, wherein applying the magnetic field comprises initially setting a polarity of each electromagnet of the plurality of electromagnets and changing the polarity of at least one electromagnet of the plurality of electromagnets after a predetermined time period.

EC 30. The method of any of the preceding or subsequent example combinations, wherein changing the polarity comprises changing the polarity of each electromagnet of the plurality of electromagnets in a predetermined pattern for a stirring time period.

EC 31. The method of any of the preceding or subsequent example combinations, wherein the predetermined pattern is a stepped pattern around the at least one electrode.

EC 32. The method of any of the preceding or subsequent example combinations, wherein the stirring time period is from about 250 ms to about 500 ms.

EC 33. The method of any of the preceding or subsequent example combinations, wherein the predetermined time period is from about 0.5 seconds before welding begins to about 1 second after welding ends.

EC 34. The method of any of the preceding or subsequent example combinations, wherein the polarities of each of the plurality of electromagnets are initially set to the same polarity.

EC 35. The method of any of the preceding or subsequent example combinations, wherein adjusting the magnetic field comprises changing at least one of the plurality of electromagnets on the magnet carrier or a diameter of at least one of the plurality of electromagnets.

EC 36. The method of any of the preceding or subsequent example combinations, wherein the first metal sheet comprises a first aluminum alloy and the second metal sheet comprises a second aluminum alloy, wherein the first aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy, and wherein the second aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy.

EC 37. The method of any of the preceding or subsequent example combinations, wherein the first aluminum alloy is different from the second aluminum alloy.

EC 38. The method of any of the preceding or subsequent example combinations, wherein the first aluminum alloy and the second aluminum alloy are the same series aluminum alloy.

EC 39. A weld formed by the method of any of the preceding or subsequent example combinations.

EC 40. A method of resistance spot welding comprising: positioning a first metal sheet and a second metal sheet between two electrodes, wherein at least one of the electrodes comprises a magnet carrier comprising a plurality of electromagnets, wherein at least one of the first metal sheet and the second metal sheet comprises a 7xxx series aluminum alloy; clamping the two electrodes together; applying a current to the first metal sheet and the second metal sheet through the two electrodes to form a weld nugget; and applying a magnetic field through the weld nugget through the plurality of electromagnets surrounding the two electrodes, wherein forming the weld nugget joins the first metal sheet with the second metal sheet.

EC 41. The method of any of the preceding or subsequent example combinations, wherein applying the magnetic field causes stirring within a portion of the first metal sheet and the second metal sheet forming the weld nugget, and wherein the method further comprises adjusting the magnetic field to adjust the stirring.

EC 42. The method of any of the preceding or subsequent example combinations, wherein adjusting the magnetic field comprises at least one of adjusting a number of the plurality of electromagnets, a diameter of each electromagnet of the plurality of electromagnets, an angle of a central axis of each electromagnet of the plurality of electromagnets relative to a central axis of the at least one electrode, or a pattern of changing a polarity of each electromagnet of the plurality of electromagnets.

EC 43. A weld formed by the method of any of the preceding or subsequent example combinations.

EC 44. A resistance spot welding system comprising: a magnet carrier defining a receiving passage that is configured to receive an electrode of the resistance spot welding system; and a plurality of electromagnets on the magnet carrier such that the plurality of electromagnets are positioned around the electrode when the magnet carrier is positioned on the electrode.

EC 45. The resistance spot welding system of any of the preceding or subsequent example combinations, wherein a central axis of at least one electromagnet of the plurality of electromagnets is parallel to a central axis of the receiving passage.

EC 46. The resistance spot welding system of any of the preceding or subsequent example combinations, wherein a central axis of at least one electromagnet of the plurality of electromagnets is angled at a non-parallel angle relative to a central axis of the receiving passage.

EC 47. The resistance spot welding system of any of the preceding or subsequent example combinations, wherein a position of at least one electromagnet of the plurality of electromagnets is fixed relative to the magnet carrier.

EC 48. The resistance spot welding system of any of the preceding or subsequent example combinations, wherein a position of at least one electromagnet of the plurality of electromagnets is adjustable relative to the magnet carrier.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed:

1. A method of resistance spot welding comprising:
positioning a magnet carrier on at least one electrode of two electrodes, the magnet carrier comprising a plurality of electromagnets positioned around the at least one electrode;
positioning a first metal sheet and a second metal sheet between the two electrodes, wherein at least one of the first metal sheet or the second metal sheet comprises an aluminum alloy;
positioning the two electrodes on opposing surfaces of the first metal sheet and the second metal sheet; and
forming a weld nugget by:
applying a magnetic field from the plurality of electromagnets through the weld while applying a current through the electrodes to stir a portion of the first metal sheet and the second metal sheet forming a weld nugget; and
adjusting the magnetic field to control at least one characteristic of the weld nugget,
wherein forming the weld nugget joins the first metal sheet with the second metal sheet.

2. The method of claim 1, wherein adjusting the magnetic field comprises controlling an angle of a central axis of at least one electromagnet of the plurality of electromagnets with respect to a central axis of the at least one electrode.

3. The method of claim 2, wherein controlling the angle of the central axis of the at least one electromagnet comprises angling the central axis of the at least one electromagnet such that the central axis of the at least one electromagnet is parallel to the central axis of the at least one electrode, a pole of the at least one electromagnet is angled inwards and towards the at least one electrode, or the pole of the at least one electromagnet is angled outwards and away from the at least one electrode.

4. The method of claim 1, wherein applying the magnetic field comprises initially setting a polarity of each electromagnet of the plurality of electromagnets and changing the polarity of at least one electromagnet of the plurality of electromagnets after a predetermined time period.

5. The method of claim 4, wherein changing the polarity comprises changing the polarity of each electromagnet of the plurality of electromagnets in a predetermined pattern for a stirring time period.

6. The method of claim 5, wherein the stirring time period is from about 250 ms to about 500 ms.

7. The method of claim 4, wherein the predetermined time period is from about 0.5 seconds before welding begins to about 1 second after welding ends.

8. The method of claim 4, wherein the polarities each one of the plurality of electromagnets are initially set to the same polarity.

9. The method of claim 1, wherein adjusting the magnetic field comprises changing at least one of a number of the plurality of electromagnets on the magnet carrier or a diameter of at least one of the plurality of electromagnets.

10. The method of claim 1, wherein the first metal sheet comprises a first aluminum alloy and the second metal sheet comprises a second aluminum alloy, wherein the first aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy, and wherein the second aluminum alloy is selected from a group consisting of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy.

11. The method of claim 10, wherein the first aluminum alloy is different from the second aluminum alloy.

12. The method of claim 11, wherein the first aluminum alloy and the second aluminum alloy are the same series aluminum alloy.

13. A method of resistance spot welding comprising:
positioning a first metal sheet and a second metal sheet between two electrodes, wherein at least one of the electrodes comprises a magnet carrier comprising a plurality of electromagnets, wherein at least one of the first metal sheet and the second metal sheet comprises a 7xxx series aluminum alloy;
clamping the two electrodes together;
applying a current to the first metal sheet and the second metal sheet through the two electrodes to form a weld nugget; and
applying a magnetic field through the weld nugget through the plurality of electromagnets surrounding the two electrodes,
wherein forming the weld nugget joins the first metal sheet with the second metal sheet.

14. The method of claim 13, wherein applying the magnetic field causes stirring within a portion of the first metal sheet and the second metal sheet forming the weld nugget, and wherein the method further comprises adjusting the magnetic field to adjust the stirring.

15. The method of claim 14, wherein adjusting the magnetic field comprises at least one of adjusting a number of the plurality of electromagnets, a diameter of each electromagnet of the plurality of electromagnets, an angle of a central axis of each electromagnet of the plurality of electromagnets relative to a central axis of the at least one electrode, or a pattern of changing a polarity of each electromagnet of the plurality of electromagnets.

16. A resistance spot welding system comprising:
a magnet carrier defining a receiving passage that is configured to receive an electrode of the resistance spot welding system; and
a plurality of electromagnets on the magnet carrier such that the plurality of electromagnets are positioned around the electrode when the magnet carrier is positioned on the electrode.

17. The resistance spot welding system of claim 16, wherein a central axis of at least one electromagnet of the plurality of electromagnets is parallel to a central axis of the receiving passage.

18. The resistance spot welding system of claim 16, wherein a central axis of at least one electromagnet of the plurality of electromagnets is angled at a non-parallel angle relative to a central axis of the receiving passage.

19. The resistance spot welding system of claim 16, wherein a position of at least one electromagnet of the plurality of electromagnets is fixed relative to the magnet carrier.

20. The resistance spot welding system of claim 16, wherein a position of at least one electromagnet of the plurality of electromagnets is adjustable relative to the magnet carrier.
